(19) United States
(12) Patent Application Publication
(10) Pub. No.: US 2025/0305823 A1
(43) Pub. Date: Oct. 2, 2025

(54) PIPE LEVEL DEVICE AND METHODS

(71) Applicants: William Coan, III, New Lenox, IL (US); Mark Simon, New Lenox, IL (US)

(72) Inventors: William Coan, III, New Lenox, IL (US); Mark Simon, New Lenox, IL (US)

(21) Appl. No.: 18/617,195

(22) Filed: Mar. 26, 2024

(51) Int. Cl. G01C 9/28; F16L 55/07

(52) U.S. Cl. CPC G01C 9/28; F16L 55/07

(57) ABSTRACT

A one-piece pipe level device including a level-vial mount for removably mounting an elongate level element (such as a bubble level vial) in each of two orthogonal orientations. The collar has a c-clip shape with a closed side, an open side, and open axial ends. The level-vial mount is disposed on the closed side facing outwardly. The mount includes a mounting channel for retaining the level vial in the first orientation, the channel having mounting notches cut out of its opposite walls for retaining the level vial in the second orientation. The collar has a pair of flex members connected at their respective proximal ends to the mount and extending in opposite circumferential directions to their respective distal ends. The distal ends straddle the open side of the collar.

### CROSS-REFERENCE

None.

### FIELD OF THE DISCLOSURE

The present disclosure relates to pipe levels. More particularly, it relates to levels that provide horizontal and vertical level readings for a pipe when removably attached to the pipe.

### SUMMARY

According to an aspect of the disclosure, a pipe level device includes a collar body comprising a level element mount and a pair of opposed circumferentially extending flex members. The collar body has a longitudinal axis, first and second longitudinal ends, an inner surface facing radially inwardly toward the axis, an outer side spaced radially outwardly from the inner surface and facing radially outwardly, the inner surface extending longitudinally from the first longitudinal end to the second longitudinal end and circumferentially about the axis from a first circumferential end to a second circumferential end, the collar body forming a pipe channel. The pipe channel has a periphery comprising the inner surface and an open side opposite the inner surface, the pipe channel having first and second open longitudinal ends at the first and second longitudinal ends of the collar body. The level element mount is disposed on the outer side of the collar body and comprises a longitudinal level mounting seat and an orthogonal level mounting seat, the longitudinal level mounting seat being operative to removably retain an elongate level element in a longitudinal mounted position, the orthogonal level mounting seat being operative to removably retain a level element in an orthogonal mounted position. The level element for use with the collar body has a level element axis, the level element axis in the longitudinal mounted position being parallel to the collar body axis, the level element axis in the orthogonal mounted position being orthogonal to the collar body axis, the level element in the longitudinal mounted position occupying a portion of a volume occupied by the level element in the orthogonal mounted position. Each flex member has a proximal end and a distal end and is connected to the level element mount at its proximal end, The first and second flex members extend in respective first and second opposite circumferential directions from their respective proximal ends to their respective distal ends. The collar body inner surface is comprised within a circumferential span of the collar body extending in the second circumferential direction from the first flex member distal end to the second flex member distal end.

### BRIEF DESCRIPTION OF THE DRAWINGS

Although the characteristic features of this disclosure will be particularly pointed out in the claims, the disclosed device and method, and how it may be made and used, may be better understood by referring to the following description taken in connection with the accompanying drawings forming a part hereof, wherein like reference numerals refer to like parts throughout the several views and in which:

FIG. 1 is a top left first-end perspective view of a pipe level device according to an aspect of the invention.

FIG. 2 is a first-end elevation view of the pipe level device of FIG. 1.

FIG. 3 is a left side elevation view of the pipe level device of FIG. 1.

FIG. 4 is a top plan view of the pipe level device of FIG. 1.

FIG. 5 is a perspective view of the pipe level device of FIG. 1 including a removably attached level element in a longitudinal mounted position, illustrating a method of use for determining the pitch of a generally horizontal section of drain pipe.

FIG. 6 is a perspective view of the pipe level device of FIG. 1 including a removably attached level element in an orthogonal mounted position, illustrating a method of use for confirming the vertical orientation of a generally vertical pipe.

A person of ordinary skill in the art will appreciate that elements of the figures above are illustrated for simplicity and clarity and are not necessarily drawn to scale. The dimensions of some elements in the figures may have been exaggerated relative to other elements to help to understand the present teachings. Furthermore, a particular order in which certain elements, parts, components, modules, steps, actions, events and/or processes are described or illustrated may not be required. A person of ordinary skills in the art will appreciate that, for simplicity and clarity of illustration, some commonly known and well-understood elements that are useful and/or necessary in a commercially feasible embodiment may not be depicted to provide a clear view of various embodiments per the present teachings.

### DETAILED DESCRIPTION

In the following description of various examples of embodiments of the disclosed device, reference is made to the accompanying drawings, which form a part hereof. Other specific arrangements of parts and environments can be used, and structural modifications and functional modifications can be made without departing from the scope of the disclosed device and methods.

As illustrated in the accompanying drawings and described herein, the present disclosure provides a one-piece pipe level device including a two-way mount for removably mounting a level vial in a first, parallel orientation and a second, orthogonal orientation relative to a flow axis of a pipe when the pipe level device is removably connected to the pipe.

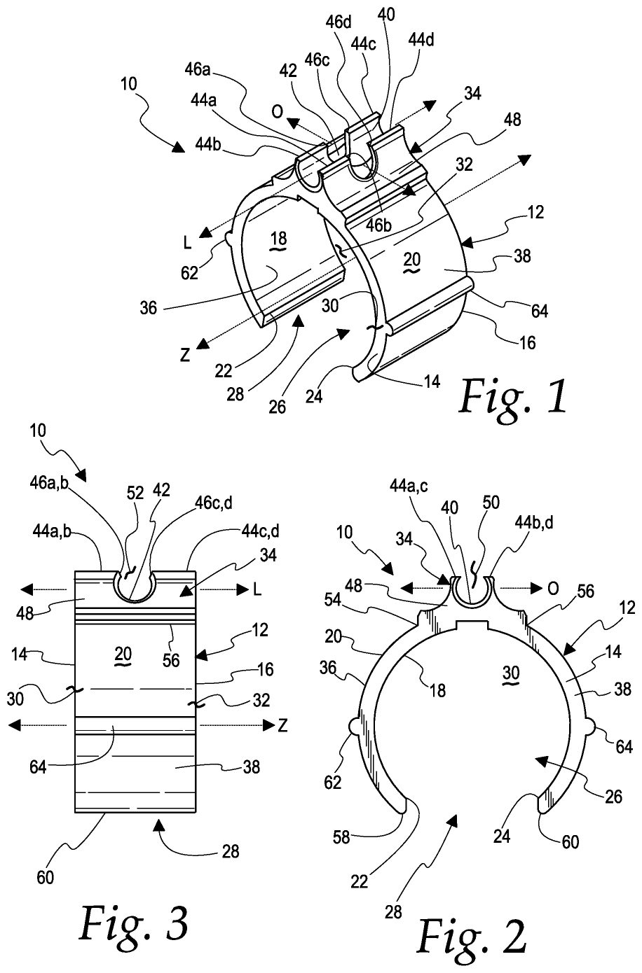

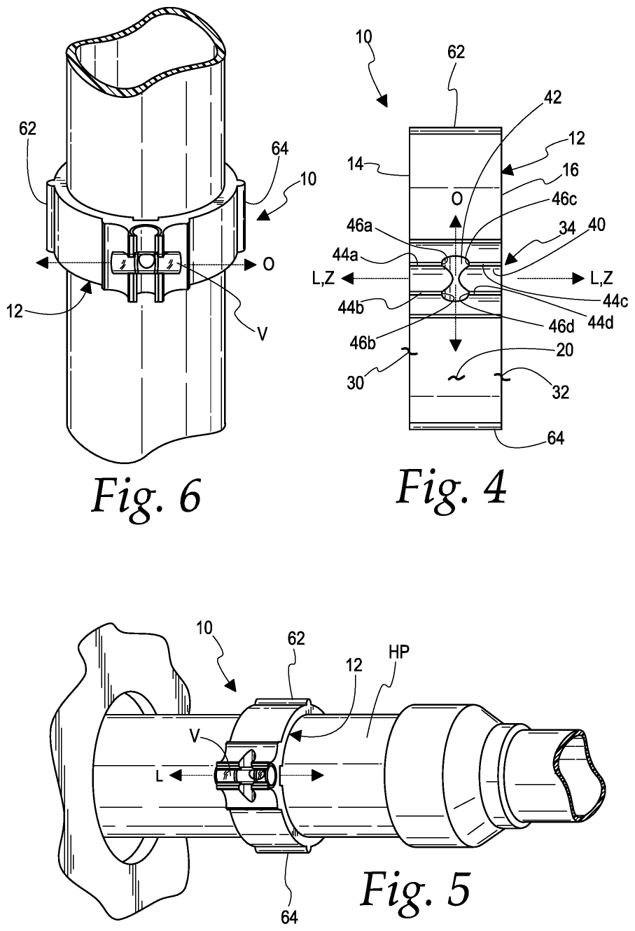

Turning now to the drawings, shown in FIGS. 1-4 are various views of a pipe level device 10, and methods of using the pipe level device 10 are illustrated in FIGS. 5 and 6. The device 10 comprises a collar body 12, the collar body having a longitudinal z-axis, first and second longitudinal ends 14, 16, an inner surface 18 facing radially inwardly toward the z-axis, and an outer side 20 spaced radially outwardly from the inner surface 18 and facing radially outwardly. The inner surface 18 extends longitudinally from the first longitudinal end 14 to the second longitudinal end 16 and circumferentially about the z-axis from a first circumferential end 22 to a second circumferential end 24, the collar body 12 forming a pipe channel 26, the pipe channel 26 having a periphery comprising the inner surface 18 and an open side 28 opposite the inner surface 18, the pipe channel 26 having first and second open longitudinal ends 30, 32 at the first and second longitudinal ends 14, 16, respectively, of the collar body 12.

Structural elements of the collar body 12 comprise a level element mount 34 and first and second opposed flex members 36, 38. The level element mount 34 is disposed on the outer side 20 of the collar body 12 and comprises a longitudinal level mounting seat 40 and an orthogonal level mounting seat 42. The longitudinal level mounting seat 40 is operative to removably retain an elongate level element, such as that illustrated in FIGS. 5 and 6 as a bubble level vial V, in a longitudinal mounted position, as shown in FIG. 5, while the orthogonal level mounting seat 42 is operative to removably retain the same elongate level element (or one of the same size and shape) in an orthogonal mounted position, as shown in FIG. 6. The level element has a level element axis, such as that of the bubble level vial V, designated as a longitudinal L-axis in FIG. 5 and as an orthogonal O-axis in FIG. 6. The L-axis of the level element in the longitudinal mounted position is parallel to the z-axis of the collar body 12, and thus parallel to the (pitched) horizontal pipe HP shown in FIG. 5, while the level element axis in the orthogonal mounted position is orthogonal to the collar body z-axis, and thus orthogonal to the vertical pipe VP shown in FIG. 6.

The longitudinal level mounting seat 40 intersects the orthogonal level mounting seat 42, such that the level element in the illustrated longitudinal mounted position occupies a portion of a volume occupied by the level element in the illustrated orthogonal mounted position. More particularly, the longitudinal and orthogonal mounting seats 40, 42 bisect or approximately bisect each other. This arrangement makes the level element mount 34 relatively compact, while likewise limiting the combined “footprint” of the level element itself in its two mounted positions, thus reducing or eliminating the need to reposition the collar body 12 on a pipe P to make the level element readily visible so as to be readable, and/or to make room for the level element, in its use environment in each position. Also, compared to certain existing pipe level devices in which separate (pitched) horizontal-pipe and vertical-pipe level elements are permanently retained, the pipe level device 10 provides the advantage of allowing the interchangeable substitution of level elements of like size and shape in the element mount 34, so that an entire device does not need to be replaced, for example, when a level element breaks or becomes difficult to read due to wear, or an entire device substituted when it is only a different type of level element that is preferred, such as a bubble level vial with a color of liquid preferred for visibility in a particular environment.

The longitudinal mounting seat 40 comprises at least one pair of opposed longitudinal gripping members 44a-d, the second mounting seat comprising at least one pair of opposed orthogonal gripping members 46a-d, each pair of opposed gripping members 44 or 46 being operative to circumscribe a portion of a circumference of a cross section of the level element perpendicular to the level element axis L, O in the respective longitudinal or orthogonal mounted position and being spaced apart at opposite sides of the level element axis L, O in the respective longitudinal or orthogonal mounted position so as to permit the level element to be inserted manually between the pair of opposed gripping members 44 or 46 in a direction perpendicular to the level element axis L, O.

More particularly, the level element mount 34 further comprises a base 48, the base 48 being connected to the collar body flex members 36, 38, the pairs of opposed gripping members 44, 46 having proximal ends connected to the base 48 and extending radially outwardly with respect to the collar body axis and towards each other from their proximal ends to respective distal ends so as to define a respective distal opening 50 (FIG. 2), 52 (FIG. 3) between the distal ends of the gripping members 44, 46 that is narrower than a widest dimension of the circumscribed portion of the cross section of the level element in the respective longitudinal or orthogonal mounting position.

Still more particularly, said at least one pair of opposed longitudinal gripping members 44a-d comprises a first such pair 44a, 44b and a second such pair 44c, 44d, while said at least one pair of opposed orthogonal gripping members 46a-d comprises a first such pair 46a, 46c and a second such pair 46b, 46d. In addition, it will be noted that, as illustrated, the level element mount 34 includes only four separate radially outward protrusions a-d from the base 48, each protrusion a-d operating as the corresponding longitudinal gripping member 44a-d when the level element is in the longitudinal mounted position and as the corresponding orthogonal gripping member 46a-d when the level element is in the orthogonal mounted position, the reference signs 44a-d, 46a-d indicating the gripping sides or faces of the protrusion that correspond to its operation as a longitudinal gripping member or as an orthogonal gripping member, respectively.

Further, each of the longitudinal mounting seat 40 and the orthogonal mounting seat 42 comprises a partial circular cylindrical longitudinal channel 40, 42 formed by its respective gripping members 44a-d, 46a-d. Each longitudinal or orthogonal channel 40, 42 is thus sized to receive a circular cylindrical level element such as the bubble-level vial V. More particularly, each channel 40, 42 extends continuously over an arc of at least one hundred eighty degrees about the bubble-level vial axis L, O in the respective longitudinal or orthogonal mounted position. The longitudinal channel 40 and the orthogonal channel 42 intersect each other, and more particularly their respective axes or lengths bisect or approximately bisect each other, which provides certain benefits as discussed above.

As indicated in FIG. 2, each of the first and second flex members 36, 38 has a respective proximal end 54, 56 and a respective distal end 58, 60. Each flex member 36, 38 is connected to the level element mount 34 at its respective proximal end 54, 56, and the first and second flex members 36, 38 extend in respective first and second opposite circumferential directions from their respective proximal ends 54, 56 to their respective distal ends 58, 60. The collar body inner surface 18 is comprised within a circumferential span of the collar body 12 that extends in the second circumferential direction from the first flex member distal end 58 to the second flex member distal end 60. More particularly, the circumferential span of the collar body 12 is greater than one-hundred eighty degrees, and still more particularly greater than two-hundred sixty degrees, still more particularly being two-hundred seventy degrees or approximately two-hundred seventy degrees. The collar body 12 further comprises one or more visual indicators 62, 64 disposed on its outer side 20, the visual indicators 62, 64 being disposed at (and so indicating for purposes of a method described below with reference to FIG. 6) an angular position offset ninety degrees about the collar body axis from the L-axis of the longitudinal mounting seat 40, and thus being at angular positions one-hundred eighty degrees apart from each other. As illustrated, each visual indicator 62, 64 comprises a longitudinally elongate, radially outward protrusion circumferentially overlapping the position on the collar body 12 offset ninety degrees from the longitudinal level mounting seat 40.

According to a method of use illustrated in FIG. 5, the pipe level device 10 is snapped onto a (pitched) horizontal pipe HP having a diameter equal to or slightly larger than that of the collar body inner surface 18, and greater than an orthogonal span of the open side 28, by pressing the open side 28 of the collar body 12 in a radial direction against a side of the pipe HP with the collar body z-axis aligned parallel to the pipe HP, so that the flex members 36, 38 flex and their distal ends 58, 60 deflect to expand the open side 28 for the pipe HP to pass therethrough and into the pipe channel 26, in close contact with the collar body inner surface 18. Before or after the collar body 12 is so attached to the pipe HP, the bubble level vial V is similarly snapped into the longitudinal mounted position in the longitudinal mounting seat 40 of the level mount 34. In any rotational orientation of the collar body 12 relative to the pipe HP, the L-axis of the longitudinally mounted bubble level vial V will be parallel to the pipe HP, and thus the position of the bubble in the vial V being offset from a centered position between the indicator lines toward one end of the vial V will indicate that the pipe HP is pitched upwardly toward that end of the vial V. This allows a user to confirm whether the pipe HP is pitched upwardly in an intended upstream direction towards a drain, and thus downwardly in an intended downstream direction of drain flow away from the drain.

According to a method of use to confirm the vertical orientation of a vertical pipe VP as shown in FIG. 6, the collar body 12 is similarly snapped onto the pipe VP and the bubble level vial V is snapped into the orthogonal mounting seat 42 of the level mount 34. If the pipe VP is properly oriented vertically, then the bubble-level vial V will read horizontal with the collar body 12 rotated to any position about the circumference of the pipe VP, whereas if the pipe VP is tilted from vertical, the bubble level vial V will read horizontal in only two positions, at the high and low sides of the segment of the pipe VP where the collar body 12 is positioned, and will indicate a greatest pitched angle at ninety degrees from the high and low sides. Thus, if the vial V reads horizontal with the collar body 12 in each of two positions rotated ninety degrees about the circumference of the vertical pipe VP, it can be determined with reasonable certainty that the pipe VP is vertically aligned. Accordingly, the method includes observing a horizontal reading in the orthogonally mounted bubble-level vial V with the collar body 12 in a first rotational position about the vertical pipe VP, observing a point on the vertical pipe VP at the circumferential position of the longitudinal mounting seat 40, rotating the collar body 12 ninety degrees, or approximately ninety degrees, so that one of the visual indicators 62, 64 is at the circumferential position of said point on the vertical pipe VP (or, equivalently, observing a point at the circumferential position of one of the visual indicators 62, 64 and then rotating the collar body 12 to move the longitudinal mounting seat 40 to that point), and reading the vial V a second time at the new position of the collar body 12. A second horizontal reading of the vial V will indicate that the vertical pipe VP is oriented vertically, whereas a pitched reading of the vial V will indicate that the vertical pipe VP is tilted in the vertical plane of the vial O-axis in the new position of the collar body 12. In embodiments, if the vertical pipe VP can be tilted at the time of observing the second reading of the vial V, a user then tilts the vertical pipe VP in the vertical plane of the vial O-axis toward the offset position of the bubble until the bubble is centered in the vial V. Finally, the user rotates the collar body 12 ninety degrees or approximately ninety degrees as just described and reads the vial V again to confirm that it is still level in the position of the original reading, repeating the steps of tilting adjustments of the vertical pipe VP to level the vial V in the current vertical plane of the vial O-axis, rotating the collar body 12, and observing another reading from the vial V as necessary until both readings are level, and then affixing the position of the vertical pipe VP.

In the illustrated embodiment, the collar body 12 of the pipe level device 10 is of one-piece construction. The collar body 12 is formed of a suitable polymer material, such as by injection molding, 3-D printing, extrusion, and/or other suitable manufacturing technique(s). A suitable polymer material is sufficiently durable and flexible to permit the flex members 36, 38 to bend so as to deflect their respective distal ends 58, 60 to expand a width of the open side 28 to allow passage of a largest pipe diameter that the collar body 12 is sized to fit, which is typically somewhat larger than the diameter of the inner surface 18, such as between 5% and 25% larger, for example, and to elastically return to their initial relaxed shape, repeatedly without damage or significant plastic deformation. The level mount 34 is adapted and configured to receive and retain a level element of a standard type, such as a common type of cylindrical bubble level vial V having a 5/16-inch diameter.

The preceding description of the disclosure has been presented for purposes of illustration and description and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification, but be defined by the claims set forth below. In addition, although narrow claims may be presented below, it should be recognized that the scope of this disclosure is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional disclosures are not dedicated to the public and the right to file one or more applications to claim such additional disclosures is reserved.

What is claimed is:

1. A pipe level device comprising:
a collar body, the collar body having a longitudinal axis, first and second longitudinal ends, an inner surface facing radially inwardly toward the axis, an outer side spaced radially outwardly from the inner surface and facing radially outwardly, the inner surface extending longitudinally from the first longitudinal end to the second longitudinal end and circumferentially about the axis from a first circumferential end to a second circumferential end, the collar body forming a pipe channel, the pipe channel having a periphery comprising the inner surface and an open side opposite the inner surface, the pipe channel having first and second open longitudinal ends at the first and second longitudinal ends of the collar body;
the collar body comprising a level element mount and first and second opposed flex members;
the level element mount being disposed on the outer side of the collar body, the level element mount comprising a longitudinal level mounting seat and an orthogonal level mounting seat, the longitudinal level mounting seat being operative to removably retain an elongate level element in a longitudinal mounted position, the orthogonal level mounting seat being operative to removably retain a level element in an orthogonal mounted position, the level element having a level element axis, the level element axis in the longitudinal mounted position being parallel to the collar body axis, the level element axis in the orthogonal mounted position being orthogonal to the collar body axis, the level element in the longitudinal mounted position occupying a portion of a volume occupied by the level element in the orthogonal mounted position; and
each flex member having a proximal end and a distal end, each flex member being connected to the level element mount at its proximal end, the first and second flex members extending in respective first and second opposite circumferential directions from their respective proximal ends to their respective distal ends, the collar body inner surface being comprised within a circumferential span of the collar body extending in the second circumferential direction from the first flex member distal end to the second flex member distal end.

2. The pipe level device of claim 1 wherein the circumferential span of the collar body is greater than one-hundred eighty degrees.

3. The pipe level device of claim 2 wherein the circumferential span of the collar body is greater than two-hundred sixty degrees.

4. The pipe level device of claim 1 wherein the longitudinal mounting seat comprises at least one pair of opposed longitudinal gripping members, the second mounting seat comprising at least one pair of opposed orthogonal gripping members, each pair of opposed gripping members being operative to circumscribe a portion of a circumference of a cross section of the level element perpendicular to the level element axis in the respective longitudinal or orthogonal mounted position and being spaced apart at opposite sides of the level element axis in the respective longitudinal or orthogonal mounted position so as to permit the level element to be inserted manually between the pair of opposed gripping members in a direction perpendicular to the level element axis.

5. The pipe level device of claim 4 wherein the level element mount further comprises a base, the base being connected to the collar body flex members, the pairs of opposed gripping members having proximal ends connected to the base and extending radially outwardly with respect to the collar body axis and towards each other from their proximal ends to respective distal ends so as to define a distal opening between the distal ends that is narrower than a widest dimension of the circumscribed portion of the cross section of the level element in the respective longitudinal or orthogonal mounting position.

6. The pipe level device of claim 5 wherein the level element is a circular cylindrical bubble-level vial, the longitudinal mounting seat further comprising a partial circular cylindrical longitudinal channel formed by said at least one pair of opposed longitudinal gripping members, the longitudinal channel being sized to receive the bubble-level vial and extending continuously over an arc of at least one hundred eighty degrees about the bubble-level vial axis in the longitudinal mounted position, the orthogonal mounting seat further comprising an partial circular cylindrical orthogonal channel at least partially comprised by said at least one pair of opposed orthogonal gripping members, the orthogonal channel being sized to receive the bubble-level vial and extending continuously over an arc of at least one hundred eighty degrees about the bubble-level vial axis in the orthogonal mounted position, the orthogonal channel intersecting the longitudinal channel.

7. The pipe level device of claim 6 wherein said at least one pair of opposed longitudinal gripping members comprises a first such pair and a second such pair, said at least one pair of opposed orthogonal gripping members comprising a first such pair and a second such pair, each pair of opposed longitudinal gripping members being one of the first pair of orthogonal gripping members and one of the second pair of orthogonal gripping members, and each pair of opposed orthogonal gripping members being one of the first pair of longitudinal gripping members and one of the second pair of longitudinal gripping members.

8. The pipe level device of claim 1 wherein the collar body further comprises a visual indicator disposed on its outer side, the visual indicator being at an angular offset position ninety degrees about the collar body axis from the level element axis in the longitudinal mounted position.

9. The pipe level device of claim 8 wherein the visual indicator comprises a longitudinally elongate, radially outward protrusion circumferentially overlapping the angular offset position.

10. The pipe level device of claim 8 wherein said visual indicator is a first visual indicator, the collar body further comprising a second visual indicator disposed on its outer side, the second visual indicator being at an angular offset position one-hundred eighty degrees about the collar body axis from the angular offset position of the first visual indicator.

11. The pipe level device of claim 1 further comprising the collar body being of one-piece construction.

12. The pipe level device of claim 11 wherein the collar body is formed of a molded plastic material.

13. The pipe level device of claim 1, further comprising the level element, the level element being manually removably positioned in one of the longitudinal level mounting seat and the orthogonal level mounting seat.
